(19) United States
(12) Patent Application Publication
(10) Pub. No.: US 2025/0143335 A1
(43) Pub. Date: May 8, 2025

(54) METHOD OF MANUFACTURING PLANT-BASED CHEESE

(71) Applicant: Binggrae Co., Ltd., Gyeonggi-do (KR)

(72) Inventors: Jae Won HUR, Seoul (KR); Seung Geon YUN, Gyeonggi-do (KR); Young Sup SHIN, Seoul (KR); Chul Hong KIM, Gyeonggi-do (KR)

(21) Appl. No.: 18/919,428

(22) Filed: Oct. 18, 2024

(30) Foreign Application Priority Data
Nov. 8, 2023 (KR) 10-2023-0153626

(51) Int. Cl. A23C 20/02

(52) U.S. Cl. CPC A23C 20/02

(57) ABSTRACT

A method of manufacturing a plant-based cheese according to an embodiment of the present disclosure includes: manufacturing a composition for manufacturing plant-based cheese including a plant-based protein and plant-based fat; spraying oil to a cooling plate included in a cooler; supplying the composition for manufacturing plant-based cheese to the cooler; and cooling the composition for manufacturing plant-based cheese in the cooler.

### CROSS-REFERENCE TO RELATED PATENT APPLICATION

This application claims priority to Korean Patent Application No. 10-2023-0153626, filed on Nov. 8, 2023 in the Korean Intellectual Property Office, the disclosure of which is incorporated by reference herein in its entirety.

### BACKGROUND OF THE INVENTION

### 1. Field

Embodiments of the present disclosure relate to method of manufacturing a plant-based cheese.

### 2. Description of the Related Art

A vegan refers to a vegetarian who excludes animal-based raw ingredients such as meat including fish and crustaceans, dairy products, and eggs as well as all other animal-derived ingredients.

In recent years, the demand for vegan food has been steadily increasing for a variety of reasons, including animal welfare and environmental protection, ethical beliefs or religious reasons, or the accumulation of research on health benefits. According to the Korea Vegetarian and Vegan Society, the number of vegans in Korea, which was only about 150,000 in 2008, is reported to exceed 2.5 million as of 2021.

With the increasing need for vegan food, a variety of food products such as meat alternatives, frozen prepared foods, ramen, cheese, and condiments have been developed in recent years, unlike in the past when simple raw ingredients were predominant.

Among them, vegan cheese or plant-based cheese is attracting a lot of attention not only among vegans but also among consumers who are lactose intolerant or allergic to dairy products as a rich source of protein and favored food. Nonetheless, plant-based cheese have sensitive properties and are difficult to form due to its properties, making it challenging to develop a process for manufacturing the plant-based cheese.

### SUMMARY OF THE INVENTION

Embodiments of the present disclosure provide method of manufacturing a plant-based cheese that enables manufacturing of a plant-based cheese having desired properties with high process efficiency.

A method of manufacturing plant-based cheese according to an embodiment of the present disclosure includes: manufacturing a composition for manufacturing plant-based cheese including a plant-based protein and plant-based fat; spraying oil to a cooling plate included in a cooler; supplying the composition for manufacturing plant-based cheese to the cooler; and cooling the composition for manufacturing plant-based cheese in the cooler.

According to embodiments of the present disclosure, it is possible to provide method of manufacturing a plant-based cheese that enables manufacturing of a plant-based cheese having desired properties with high process efficiency.

### BRIEF DESCRIPTION OF THE DRAWINGS

FIG. 1 is a flowchart for describing method of manufacturing a plant-based cheese according to an embodiment of the present disclosure.

FIG. 2 to FIG. 4 are images showing a composition for manufacturing plant-based cheese manufactured during a process of method of manufacturing a plant-based cheese according to one embodiment of the present disclosure.

FIG. 5 and FIG. 6 are images showing plant-based cheese manufactured according to method of manufacturing a plant-based cheese according to one embodiment of the present disclosure.

FIG. 7 to FIG. 12 are images each showing a composition for manufacturing plant-based cheese manufactured during a process of method of manufacturing a plant-based cheese according to each of comparative examples of the present disclosure.

FIG. 13 to FIG. 18 are images each showing plant-based cheese manufactured according to method of manufacturing a plant-based cheese according to each of comparative examples of the present disclosure.

### DETAILED DESCRIPTION

The structural or functional descriptions of examples disclosed in the present specification or application are merely illustrated for the purpose of explaining examples according to the technical idea of the present disclosure, and examples according to the technical principle of the present disclosure may be implemented in various forms in addition to the examples disclosed in the present specification or application, and the technical idea of the present disclosure is not construed as being limited to the examples described in the present specification or application.

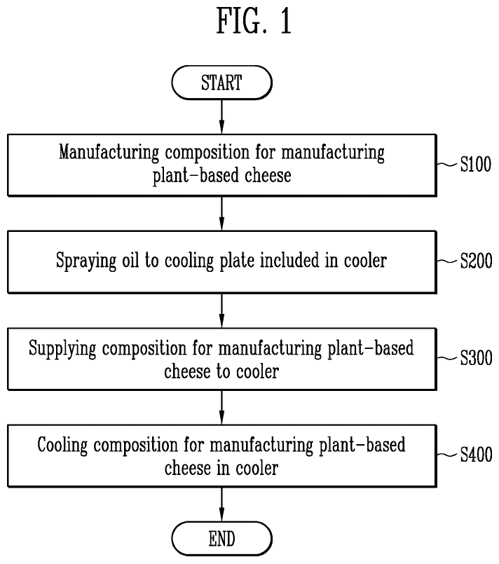

FIG. 1 is a flowchart for describing method of manufacturing a plant-based cheese according to an embodiment of the present disclosure.

Referring to FIG. 1, a composition for manufacturing plant-based cheese may be manufactured in S100. In an embodiment, S100 may include mixing raw ingredients.

The raw ingredients may include a plant-based protein and plant-based fat. In an embodiment, the plant-based protein may be, for example, potato protein, but is not limited thereto. In an embodiment, the plant-based fat may be, for example, palm oil and coconut oil, but is not limited thereto.

In an embodiment, the raw ingredients may further include a nut paste. The nut paste may be a cashew paste, oat paste, and almond paste, but is not limited thereto.

In an embodiment, the raw ingredients may further include starch. The starch may include, but is not limited to, one or more types from the group consisting of modified starch and corn starch.

In an embodiment, the raw ingredients may further include a cheesy flavor material. The selection of the cheesy flavor material may be made on the desired flavor.

In an embodiment, the raw ingredients may further include thickeners, salinity regulators, paprika extracts, carotene, preservatives, and acidity regulators. Furthermore, in an embodiment, the raw ingredients may further include water as a solvent.

In an embodiment, the mixing of the raw ingredients may be performed at 500 rpm to 620 rpm for 0.5 to 1.5 minutes. As the raw ingredients are mixed in such the range of stirring rate and stirring time, sufficient stirring may be achieved.

In an embodiment, S100 may include emulsifying and sterilizing the mixed raw ingredients.

The emulsifying and sterilizing may include stirring at 700 rpm to 1170 rpm. By performing stirring at such a range of stirring rate, it is possible to induce smooth emulsification of the composition for manufacturing cheese and achieve appropriate properties of the composition for manufacturing cheese such as viscosity.

In an embodiment, the emulsifying and sterilizing may be performed under steam pressure conditions of 3.3 bar to 10 bar until a temperature of 85° C. to 95° C. is reached. Depending on the target temperature range described above, sufficient emulsification and sterilization of the composition for manufacturing plant-based cheese and gelatinization of starch may take place. In addition, under the steam pressure conditions described above, the time to reach the target temperature may be determined within an appropriate range. For example, the time to reach the target temperature may be from 2 to 6 minutes.

In an embodiment, S100 may include stabilizing the emulsified, sterilized raw ingredients. The stabilizing may include exposing the emulsified, sterilized raw ingredients to a vacuum for more than 10 seconds. Thereby, it is possible to eliminate air bubbles in the composition for manufacturing plant-based cheese and stabilize properties of the composition for manufacturing plant-based cheese. In addition, the stabilizing may be carried out while stirring the emulsified, sterilized raw ingredients at 580 rpm to 620 rpm, wherein the temperature at this time may be maintained below 95° C.

As such, by performing S100, the composition for manufacturing plant-based cheese may be manufactured.

In an embodiment, method of manufacturing the plant-based cheese according to an embodiment of the present disclosure may further include filtering the composition for manufacturing plant-based cheese after S100. In an embodiment, the filtering may be performed by applying a pump pressure of 5 to 12 bar using a filter. With the pump pressure, the composition for manufacturing plant-based cheese with thickened properties may be transferred. At this time, the filter may include holes with a diameter of 100 μm to 1000 μm, and in one embodiment, the filter may consist of a dual filter consisting of an SUS filter and a nylon filter. Accordingly, the mixing of foreign substances may be prevented while being softened. If the hole of the filter is too small, the filter may become clogged, and if the hole of the filter is too large, the filter may not function properly.

In an embodiment, method of manufacturing the plant-based cheese according to an embodiment of the present disclosure may further include transferring the composition for manufacturing plant-based cheese after S100. In other words, the composition for manufacturing plant-based cheese may be transferred to a cooler via a transfer line. The temperature at this moment may be maintained above 70° C., thereby facilitating the transfer of the cheese with excellent flowability without hardening.

Next, oil may be sprayed onto a cooling plate included in the cooler in S200. The cooler may include the cooling plate that moves in one direction, and the cooling plate may pass through a cooling area as it moves in one direction after the composition for manufacturing plant-based cheese is applied at a later stage, resulting in the cooling of the composition for manufacturing plant-based cheese applied to the cooling plate.

In an embodiment, the oil may be lecithin oil.

In an embodiment, the temperature of the oil may be from 35° C. to 65° C. Thereby, the viscosity of the oil is maintained in a proper range to be evenly sprayed onto the composition for manufacturing plant-based cheese. In addition, an appropriate amount of oil should be sprayed so that the cooling plate and the cooled cheese may be easily separated, and the transfer of the composition for manufacturing cheeses may be carried out smoothly.

Next, in S300, the composition for manufacturing plant-based cheese may be supplied to the cooler. Specifically, the composition for manufacturing plant-based cheese may be supplied onto the cold plate in the cooler.

In one embodiment, the composition for manufacturing plant-based cheese may be applied to the cooling plate in a thickness of 1.8 mm to 2.5 mm. Within this range, the composition for manufacturing plant-based cheese may be cooled uniformly, thereby ensuring manufacturing of cheeses with excellent texture without reducing productivity.

In addition, in one embodiment, S300 may further include spraying oil to the composition for manufacturing plant-based cheese supplied onto the cooling plate. Thereby, the separation and stacking of cheeses may be facilitated in later stages.

Next, in S400, the composition for manufacturing plant-based cheese in the cooler may be cooled. As described above, the cooling of the composition for manufacturing plant-based cheese may be carried out as the cooling plate on which the composition for manufacturing plant-based cheese is applied passes through the cooling area. At this time, the temperature of the cooling area may be set to a cooling temperature using a coolant.

In an embodiment, the temperature of the coolant may be from 0° C. to 3° C. By using the temperature of the coolant in the range, the cooling temperature of the cooling area may be set appropriately, such that the composition for manufacturing cheeses may be cooled and hardened in a short time.

In addition, the rate of the cooling plate passing through the cooling area may be from 2.5 m/min to 5 m/min. Thereby, it is possible to sufficiently cool the composition for manufacturing plant-based cheese without reducing productivity.

As the composition for manufacturing plant-based cheese is cooled in S400, the plant-based cheese may be formed.

In an embodiment, method of manufacturing the plant-based cheese according to an embodiment of the present disclosure may further include cutting and stacking after S400. The temperature of the cheese to be cooled, cut, and stacked in S400 may be 5° C. to 10° C. In other words, when the temperature range of the cooled cheese is in the range described above, it may be determined that the cooling has been sufficient performed. In an embodiment, a ribbon is formed by cutting the cooled cheese, which is then stacked at intervals of 1 mm to 3 mm. Stacking with that interval range may be advantageous for separating the finished cheese products.

In an embodiment, method of manufacturing the plant-based cheese according to an embodiment of the present disclosure may further include transforming the manufactured cheese into a desired shape and packaging. The packaging may include filling with nitrogen and carbon dioxide gas, which may inhibit growth of microorganisms.

Hereinafter, method of manufacturing the plant-based cheese according to the present disclosure will be described in more detail based on Examples and Comparative Examples. However, the following Examples and Comparative Examples are only illustrative to describe the present disclosure in detail, and the disclosure is not limited to the following Examples and Comparative Examples.

### Example 1

After putting 25 wt % of plant-based fat, 15 wt % of nut paste, 15 wt % of starch, 3 wt % of plant-based protein, 2 wt % of cheese flavor ingredient, and 40 wt % of water into a cooker, the ingredients were mixed by stirring for 1 minute at 600 rpm.

Afterwards, emulsification and sterilization were carried out by stirring at 900 rpm under steam pressure conditions of 5 bar until the temperature reached at 90° C., and the composition for manufacturing plant-based cheese was obtained by exposing the mixture to a vacuum for at least 10 seconds while stirring at 600 rpm at a temperature of 90° C.

The composition for manufacturing plant-based cheese was double-filtered with a pump pressure of 8 bar using an SUS filter and a nylon filter with a hole size of 400 μm, and the filtered composition for manufacturing plant-based cheese was transferred through a transfer line with the temperature maintained at 80° C.

The composition for manufacturing plant-based cheese transferred through the transfer line was put into the cooler, but before the composition for manufacturing plant-based cheese is placed in the cooling plate in the cooler, lecithin oil at 50° C. was sprayed onto the cooling plate. Afterwards, the composition for manufacturing plant-based cheese was applied onto the cooling plate with a thickness of 2 mm.

Coolant at 1° C. was supplied to the cooling area of the cooler, and cooling was carried out as the cooling plate moves through the cooling area at a rate of 3 m/min.

After cutting the cooled cheeses at 7° C., they were stacked at intervals of 2 mm.

### Comparative Example 1-1

Except for the emulsifying and sterilizing performed at 600 rpm, plant-based cheese was manufactured in the same way as in Example 1.

### Comparative Example 1-2

Except for the emulsifying and sterilizing performed at 1200 rpm, plant-based cheese was manufactured in the same way as in Example 1.

### Comparative Example 1-3

Except for the emulsifying and sterilizing performed until the temperature reaches at 80° C., plant-based cheese was manufactured in the same way as in Example 1.

### Comparative Example 1-4

Except for the emulsifying and sterilizing performed until the temperature reaches at 100° C., plant-based cheese was manufactured in the same way as in Example 1.

### Comparative Example 1-5

Except for the emulsifying and sterilizing performed under the steam pressure of 3 bar, plant-based cheese was manufactured in the same way as in Example 1.

### Comparative Example 1-6

Except for the emulsifying and sterilizing performed under the steam pressure conditions of 12 bar, plant-based cheese was manufactured in the same way as in Example 1.

### Comparative Example 2-1

Except for the spraying of lecithin oil at 30° C., plant-based cheese was manufactured in the same way as in Example 1.

### Comparative Example 2-2

Except for the spraying of lecithin oil at 70° C., plant-based cheese was manufactured in the same way as in Example 1.

### Comparative Example 2-3

Except for the cooling performed at −2° C. on the cooling plate, plant-based cheese was manufactured in the same way as in Example 1.

### Comparative Example 2-4

Except for the cooling performed at 5° C. on the cooling plate using a coolant, plant-based

cheese was manufactured in the same way as in Example 1.

### Comparative Example 2-5

Except for applying the composition for manufacturing plant-based cheese to the cooling plate by 1.5 mm, plant-based cheese was manufactured in the same way as in Example 1.

### Comparative Example 2-6

Except for applying the composition for manufacturing plant-based cheese to the cooling plate by 3.0 mm, plant-based cheese was manufactured in the same way as in Example 1.

### Experimental Example 1

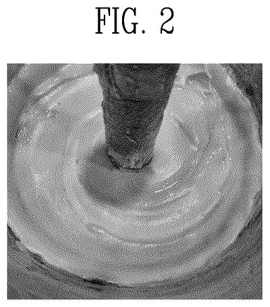

In each of Example 1 and Comparative Example 1-1 to Comparative Example 1-6, a process in which the composition for manufacturing plant-based cheese is formed was observed, which is shown in FIG. 2 to FIG. 4 and FIG. 8 to FIG. 12, respectively.

In the case of manufacturing the composition for manufacturing plant-based cheese according to the process of Example 1, the composition for manufacturing plant-based cheese with appropriate properties may be manufactured.

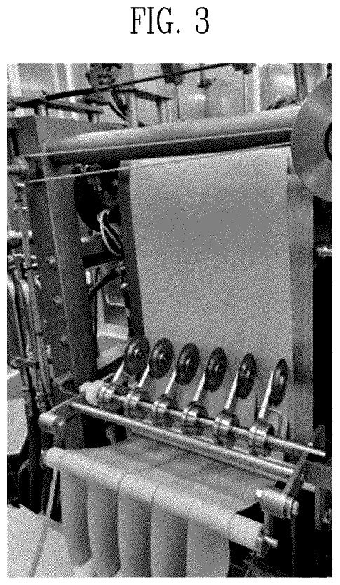

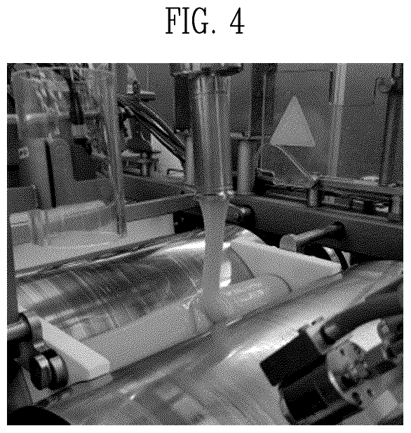

In other words, when manufacturing the composition for manufacturing plant-based cheese according to the process of Example 1, it may be noticed that the emulsification is performed well as shown in FIG. 2, with the properties suitable to be supplied to the cooler as shown in FIG. 3 and FIG. 4.

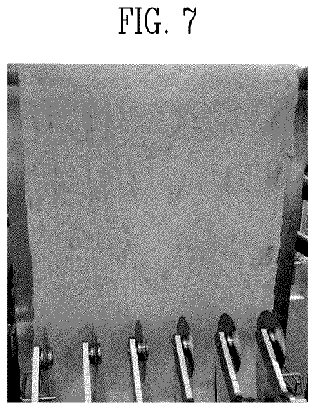

On the other hand, as in Comparative Example 1-1, when the emulsification and sterilization process is carried out at a relatively low stirring rate, it may be seen from FIG. 7 that the emulsification between the raw ingredients is not well performed, leaving stains on the surface.

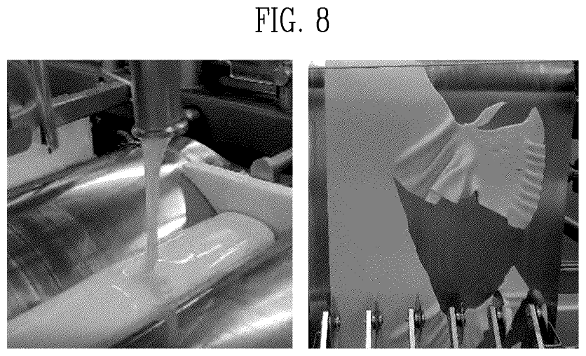

In addition, when the emulsification and sterilization process is performed at a relatively high stirring rate, as in Comparative Example 1-2, it may be seen from the left side of FIG. 8 that the viscosity of the composition for manufacturing plant-based cheese is low, thereby having excessive flowability. As a result, when the subsequent cooling process is performed, a problem arises that a cooling drum is not sufficiently filled with cheese, as shown in the right side of FIG. 8.

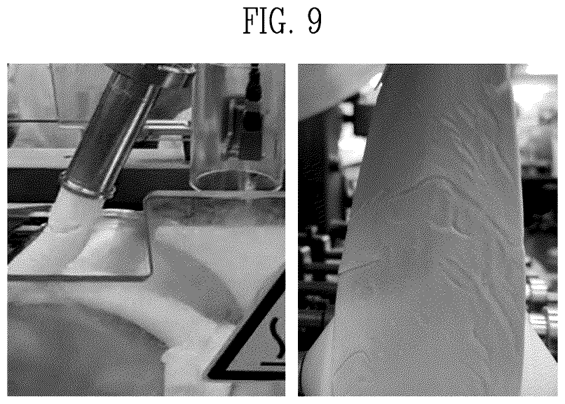

As in Comparative Examples 1-3, when the emulsification and sterilization process is carried out under relatively low temperature conditions, it may be seen from the left side of FIG. 9 that it is difficult to secure the desired properties because the mixing and the emulsification between raw ingredients are not well achieved, with no gelatinization occurred. In addition, it may be seen from the right side of FIG. 9 that the aging of starch is accelerated due to low temperature to cause formation of wavy patterns. When the composition for manufacturing plant-based cheese with such properties is filtered or transferred in the subsequent process, the filter or transfer line may become blocked to halt the production. In addition, the composition for manufacturing plant-based cheese manufactured in Comparative Example 1-3 may not be sufficiently sterilized and therefore have a high potential for microbial contamination.

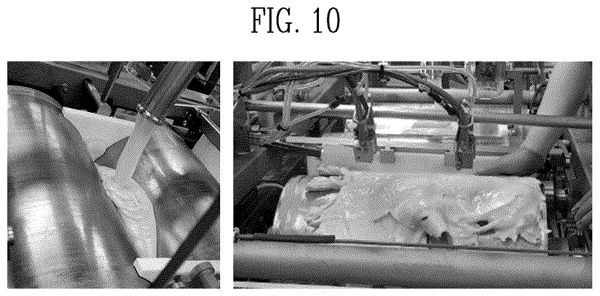

As in Comparative Example 1-4, when the emulsification and sterilization processes are carried out under relatively high temperature conditions, browning may occur, and excessive creaming reactions may degrade the quality of the composition for manufacturing plant-based cheese. In other words, as shown in the left and right sides of FIG. 10, the composition for manufacturing plant-based cheese has excessively thickened properties, thereby making it difficult to compress.

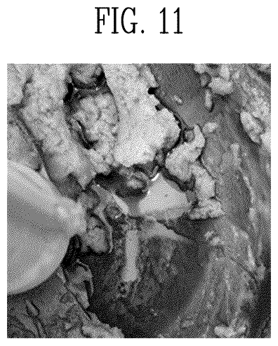

As in Comparative Example 1-5, when the emulsification and sterilization process is performed under relatively low steam pressure conditions, the emulsification may be stopped, and oil/water separation may occur as shown in FIG. 11 due to the delay in reaching the target temperature.

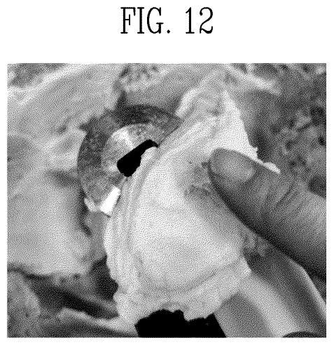

As in Comparative Example 1-6, when the emulsification and sterilization process is performed under relatively high steam pressure conditions, the target temperature may be reached so rapidly that the stirring time is insufficient, resulting in excessively thickened properties as shown in FIG. 12.

### Experimental Example 2

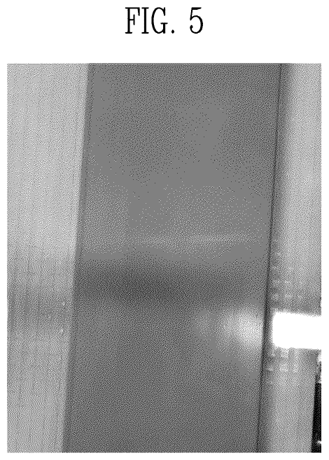

In each of Example 1 and Comparative Example 2-1 to Comparative Example 2-6, a process in which the plant-based cheese is formed by cooling the composition for manufacturing plant-based cheese was observed, which is shown in FIG. 5 to FIG. 6 and FIG. 13 to FIG. 18, respectively.

In the case of manufacturing the plant-based cheese according to the process in Example 1, the plant-based cheese may be successfully manufactured and commercialized by properly cutting and stacking the cheese.

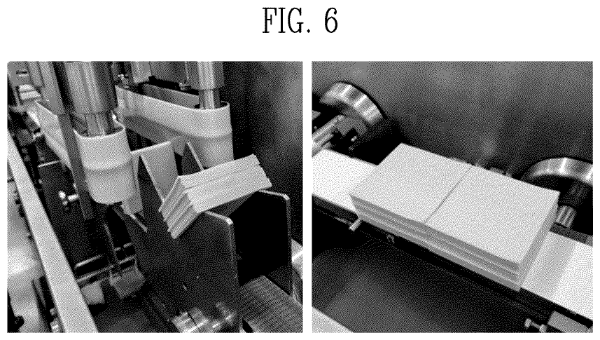

In other words, when manufacturing the plant-based cheese according to the process of Example 1, as shown in FIG. 5, it may be seen that the manufactured cheese has a smooth surface as the oil is evenly sprayed, and, as cooling and stacking are carried out smoothly, the cheese may be manufactured successfully as shown in the left and right sides of FIG. 6.

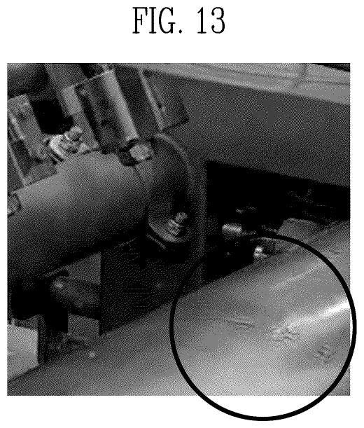

As in Comparative Example 2-1, when lecithin oil is sprayed at a relatively low temperature, the lecithin oil may not be evenly sprayed as shown in FIG. 13 due to low viscosity of the lecithin oil.

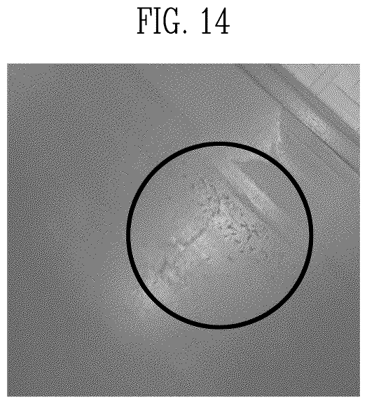

As in Comparative Example 2-2, when lecithin oil at a relatively high temperature is sprayed, the lecithin oil may volatilize and become rancid. In addition, the surface of the cheese may melt down due to the high temperature of the lecithin oil, as shown in FIG. 14.

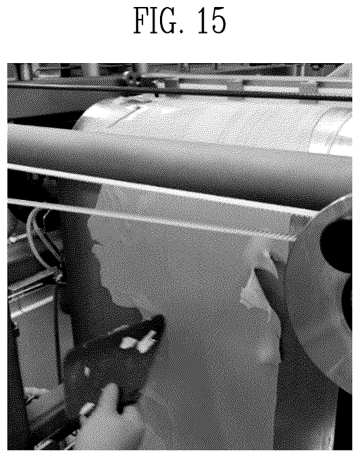

When cooling is performed at a relatively low temperature, as in Comparative Example 2-3, the cheese may be too hardened to cause breakage and loss of elasticity, as shown in FIG. 15.

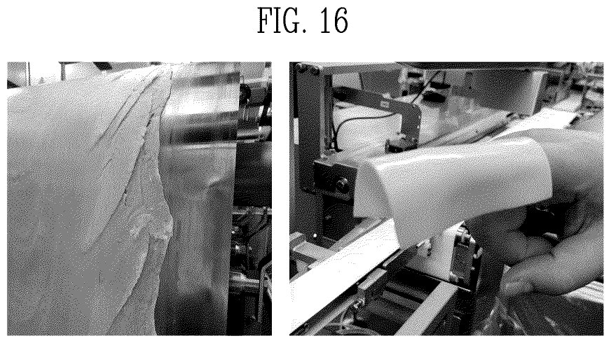

As in Comparative Example 2-4, when cooling is performed at a relatively high temperature, it may be difficult to form a ribbon for stacking, as shown in the left side of FIG. 16, and the cheese may not be separated from the cooling plate. In addition, as shown in the right side of FIG. 16, the cheese may not be firm enough to become squishy.

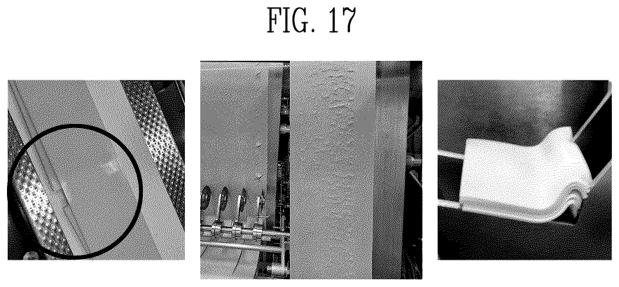

As in Comparative Example 2-5, when cooling is performed by applying the composition for manufacturing plant-based cheese with a relatively less thickness, problems may arise such as a breakage occurring in the cheese during the transfer as shown in the left side of FIG. 17, a stamping occurring on the cheese ribbon as shown in the middle of FIG. 17, or bending of the cheese rather than standing on a stacker due to the cheese being thin as shown on the right side in FIG. 17,

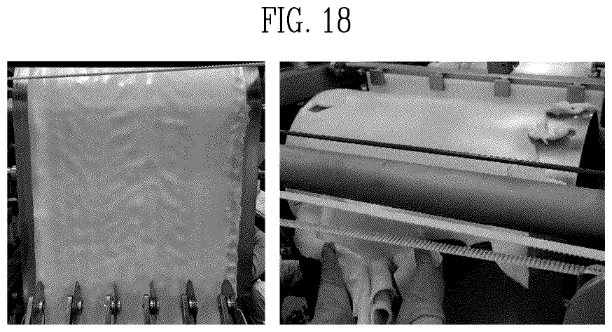

As in Comparative Example 2-6, when cooling is performed by applying the composition for manufacturing plant-based cheese with a relatively greater thickness, the problem of poor properties may arise due to insufficient cooling. In other words, as shown on the left side of FIG. 18, only the surface portion of the cheese is cooled with the inside uncooled, making the surface cry. In addition, as shown on the right side of FIG. 18, there may be a problem in that the plant- based cheese composition is deposited in the cooling drum to become clumped.

What is claimed is:

1. A method of manufacturing plant-based cheese, the method comprising:
manufacturing a composition for manufacturing plant-based cheese comprising a plant-based protein and plant-based fat;
spraying oil to a cooling plate included in a cooler;
supplying the composition for manufacturing plant-based cheese to the cooler; and
cooling the composition for manufacturing plant-based cheese in the cooler.

2. The method according to claim 1, wherein the manufacturing of the composition for manufacturing plant-based cheese comprising the plant-based protein and the plant-based fat comprises:
mixing raw ingredients comprising the plant-based protein and the plant-based fat;
emulsifying and sterilizing the mixed raw ingredients; and
stabilizing the emulsified, sterilized raw ingredients.

3. The method according to claim 2, wherein the mixing of the raw ingredients is performed at 500 rpm to 620 rpm for 0.5 to 1.5 minutes.

4. The method according to claim 2, wherein the emulsifying and sterilizing comprises stirring at 700 rpm to 1170 rpm.

5. The method according to claim 4, wherein the emulsifying and sterilizing is performed under steam pressure conditions of 3.3 bar to 10 bar until a temperature of 85° C. to 95° C. is reached.

6. The method according to claim 2, wherein the stabilizing comprises exposing the emulsified, sterilized raw ingredients to a vacuum for more than 10 seconds.

7. The method according to claim 1, wherein the supplying of the composition for manufacturing plant-based cheese to the cooler comprises applying the composition for manufacturing plant-based cheese to the cooling plate with a thickness of 1.8 mm to 2.5 mm.

8. The method according to claim 1, wherein a temperature of the oil is 35° C. to 65° C.

9. The method according to claim 1, wherein the cooling of the composition for manufacturing plant-based cheese is performed using a coolant at 0° C. to 3° C.

10. The method according to claim 9, wherein the cooling plate moves at a rate of 2.5 m/min to 5 m/min.
